(19) United States
(12) Patent Application Publication
(10) Pub. No.: US 2010/0235218 A1
(43) Pub. Date: Sep. 16, 2010

(54) PRE-QUALIFIED OR HISTORY-BASED CUSTOMER SERVICE

(75) Inventors: George ERHART, LOVELAND, CO (US); Valentine MATULA, GRANVILLE, OH (US); David SKIBA, GOLDEN, CO (US)

Correspondence Address: SHERIDAN ROSS P.C., 1560 BROADWAY, SUITE 1200, DENVER, CO, 80202, US

(73) Assignee: AVAYA INC., BASKING RIDGE, NJ (US)

(21) Appl. No.: 12/784,369

(22) Filed: May 20, 2010

Related U.S. Application Data
(63) Continuation-in-part of application No. 12/713,512, filed on Feb. 26, 2010.
Application No. 12/713,512 is a continuation-in-part of application No. 12/702,764, filed on Feb. 9, 2010.
Application No. 12/702,764 is a continuation-in-part of application No. 12/566,558, filed on Sep. 24, 2009.
Application No. 12/566,558 is a continuation-in-part of application No. 12/561,459, filed on Sep. 17, 2009.
Application No. 12/561,459 is a continuation-in-part of application No. 12/490,247, filed on Jun. 23, 2009.
Application No. 12/490,247 is a continuation-in-part of application No. 12/328,620, filed on Dec. 4, 2008.
Application No. 12/328,620 is a continuation-in-part of application No. 12/242,475, filed on Sep. 30, 2008.
Application No. 12/242,475 is a continuation-in-part of application No. 12/242,005, filed on Sep. 30, 2008.
Application No. 12/242,005 is a continuation-in-part of application No. 12/240,256, filed on Sep. 29, 2008.

(51) Int. Cl. G06Q 10/00; G06Q 30/00

(52) U.S. Cl. 705/9; 705/345; 705/10; 705/8

(57) ABSTRACT

System and methods are presented to receive presence information about a customer of an enterprise. The presence information can be geo-presence information, which may be provided by a geo-presence system or by a third party. Information within the geo-presence information can identify the customer. With the identity, personal information about the customer can be retrieved. The personal information can include aggregations or associations of the customer and other people, places, items, etc. From the presence and personal information, the system can inform, direct, or modify interactions with customers. The changes to the interactions can target customers that the enterprise may value more and may be more willing to engage in consumer activity.

### BACKGROUND

Generally, consumers can purchase goods or services either through an Internet website or at a brick and mortar store. Internet websites can often offer better prices but cannot offer the same personalized customer service an employee may offer in a brick and mortar store. As such, brick and mortar stores often rely on customer service to differentiate the store from Internet competitors and to give the brick and mortar store a strategic advantage. Thus, brick and mortar stores are always looking for new ways to enhance the customer experience.

However, all businesses face common problems. Owing to payroll expense, physical plant costs, contractual obligations, and other considerations, all businesses desire to allocate staff, resources, services, or the like quickly and efficiently to dynamic business problems. Generally, existing customer service efforts make use of centralized contact centers, customer service counters, store employees and managers, and/or kiosks. These systems fail to distinguish where the customer and items of interest are, what part of the shopping experience the customer is engaged, or what urgency the customer may have. As such, there is a need for more effective and efficient customer service systems and methods.

### SUMMARY

It is with respect to the above issues and other problems that the embodiments presented herein were contemplated. Embodiments described herein generally relate to systems and methods to receive presence information about a customer of an enterprise. The presence information can be geo-presence information, which may be provided by a geo-presence system or by a third party. Information within the geo-presence information can identify the customer. With the identity, personal information about the customer can be retrieved. The personal information can include aggregations or associations of the customer and other people, places, items, etc. From the presence and personal information, the system can inform, direct, or modify interactions with customers. The changes to the interactions can target customers that the enterprise may value more and may be more willing to engage in consumer activity.

The embodiments proposed herein use historical information along with a decision support system to anticipate and select strategies to address both opportunities and threats common to environments found in retail, entertainment, or the like. A high-priced retail outlet (brick and mortar) can best differentiate itself through the premium services described herein. Due to the volume of traffic and due to the fact that there are both browsing people and serious buyers, a brick and mortar enterprise needs to determine how to best deploy their staff and how to effectively rate customers. Information about a customer and an alert of their presence is desirable. If there are too many customers to handle, high profile customers can be handled first. The historical information used includes, but is not limited to, aggregations of people and/or items, events, results of previous strategies, and preanalyzed information saved for future use. Things associated with customers, for example, MAC addresses, Bluetooth, RFID cards, products, clothing, events, results of past strategies, or the like may be are registered and classified for future use to provide anticipatory responses when the customers are encountered again. The items can be registered singularly or as arbitrary aggregations. Responses may vary depending on the aggregation involved. However, in general, the aggregation can be identified, ranked, and classified, then strategies may be associated with the aggregations to promptly, efficiently, and bidirectionally route staff, services, products, or the like. Information can be available via mobile and/or non-mobile displays, or the like, using techniques known to those schooled in the art. Examples of strategies targeting customers may include offering the customer a preferred refreshment (known for aggregation), complimenting them on particular tastes that suits their vanity or their choice of shopping companions, inquiring about past purchases, gaining confidence, eliminating departure without assistance, triage for special circumstances, recognizing values/trends/patterns of past purchases, alerting the customers to prequalified, proactive, and/or personalized offers that suit their interests. Examples of offers can include higher credit limits, renewable warranties about to expire, past/current/upcoming sales, tempting add-on or up sold items or classes of such, etc.

The embodiments provide rich opportunities to prioritize arbitrary aggregations and act on aggregations in real time. Examples include, but are not limited to, ranking customers by expertise, sales potential, readiness to buy, prequalification level, and other designations known to the business. Also, routing the customers to staff with appropriate expertise, training, or the like, who are armed with appropriate sales strategies, or the like. Another example is grouping customers for a common sales pitch, point-of-sale processing, after sale processing, training, or the like known to the business, to increase margins and to make efficient use of staff and other resources of the business. Another example is bundling and aggregating products, services, or the like, to target individual customers or groups of customers to increase margins, reduce inventory, and to address other needs of the business, by creating peer pressure on individual customers forming the group, and/or other leverage on individuals and/or the group.

Another example strategy would route highly valued customers (e.g., high rollers) to more expensive and higher margin premium products, services, and opportunities, such as special concierge services, among other services known to the business. Another example strategy would identify staff or other non-customers in the store that, even though they are on personal business, could be drafted to help out. Bad, dissatisfied, unhappy, truculent, and similarly troublesome and challenging customers could be routed to special staff members and/or teams trained in discretion and psychology to exploit foibles, and other such techniques known to the business. Similarly, troublesome non-customers can be quickly and efficiently identified for efficient, prompt, and discreet treatment. Non-customers may be, but are not limited to, criminals, shoplifters, individuals under a restraining order, fired employees, and individuals on leave, vacation, or the like.

Aggregations of people and/or items may be excluded because of weather closure, natural disaster, or state, federal, or other laws. As with customers, staff can be quickly allocated and strategies selected when alerted to stolen items, returned products, previously sold products that the customer may have on their person, frequently returned singular and specific items, a frequently returned class of items, a class of items about to go on sale, discontinued items, recalled items, and other such items. Aggregations of people possessing aggregations of items not normally associated with them may generate alerts, strategies, or the like. Aggregations that are not yet of current or immediate interest to the business could be logged for future use. Even more advanced strategies applied to complex aggregates of people, items, business logic, or the like, may be envisioned by the embodiments.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the embodiments are considered to include a tangible storage medium and prior art-recognized equivalents and successor media, in which the software implementations are stored.

The terms “determine”, “calculate” and “compute,” and variations thereof, as used herein, are used interchangeably and include any type of methodology, process, mathematical operation or technique.

Herein, a person or object may be identified in various ways. For example, the identification may be indirect, for instance, from a guard entering an employee identifier number. Identification may be direct from the receipt of personal identifiers, such as keycard scans, biometric scans, login, radio frequency identity card interactions, etc. Further, identification may be determined through relationships, such as, an object (cell phone, truck, geo-pod, computer, etc.) being linked to a person or other object.

The term “module” as used herein refers to any known or later developed hardware, software, firmware, artificial intelligence, fuzzy logic, or combination of hardware and software that is capable of performing the functionality associated with that element.

The term “in communication with” as used herein refers to any coupling, connection, or interaction using electrical signals to exchange information or data, using any system, hardware, software, protocol, or format.

The term “event rule” or “rule” is a heuristic guideline, algorithm, logic or other software code that defines one or more events and/or one or more responses to one or more events.

The term “history profile” or “profile” can be any data structure that can define characteristics of a customer or a person or characteristics of actions associated with the customer or person. In embodiments, the history profile includes aggregations as described herein.

The preceding is a simplified summary to provide an understanding of some aspects of the embodiments. This summary is neither an extensive nor exhaustive overview of the various embodiments. It is intended neither to identify key or critical elements of the embodiments nor to delineate the scope of the claims but to present selected concepts in a simplified form as an introduction to the more detailed description presented below. As will be appreciated, other embodiments are possible utilizing, alone or in combination, one or more of the features set forth above or described in detail below.

### BRIEF DESCRIPTION OF THE DRAWINGS

The present disclosure is described in conjunction with the appended figures;

FIG. 1 is a block diagram of an embodiment of an interaction center system operable to manage employees, interface with customers, and conduct actions using geo-location information and other enterprise data;

FIG. 2 is a block diagram of an embodiment of an interaction center server operable to conduct actions in response to events associated with geo-location information;

FIGS. 3A-3C are block diagrams of embodiments of data structures that may be sent, received, or stored while trying to manage and conduct actions associated with customers having associated geo-location information;

FIG. 4 is a flow diagram of an embodiment of a process for determining a rule associated with a person having status, applying the rule, and conducting an action in response to applying the rule;

FIG. 5 is another flow diagram of an embodiment of a process for determining a rule to apply to a person associated with geo-location information;

FIG. 6 is a block diagram of an embodiment of a computer environment that may be executed with respect to the components and systems of the embodiments presented herein; and

FIG. 7 is a block diagram of a computer, which may be the same or similar to the servers, computers, devices, and/or components described herein.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It should be understood that various changes may be made in the function and arrangement of elements, without departing from the spirit and scope of the appended claims.

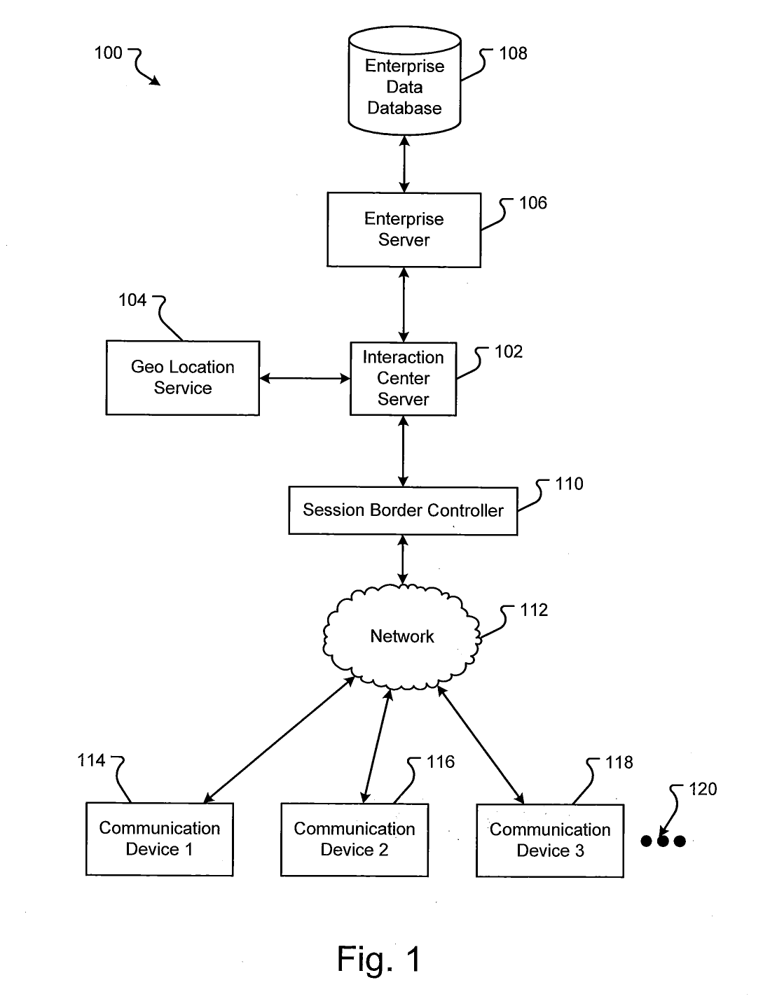

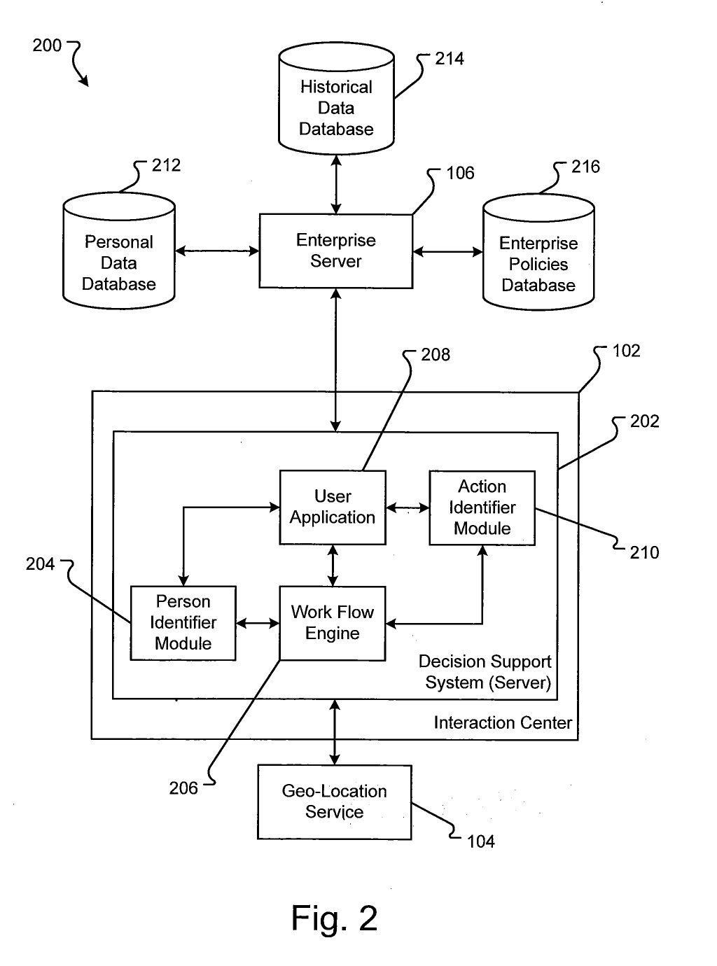

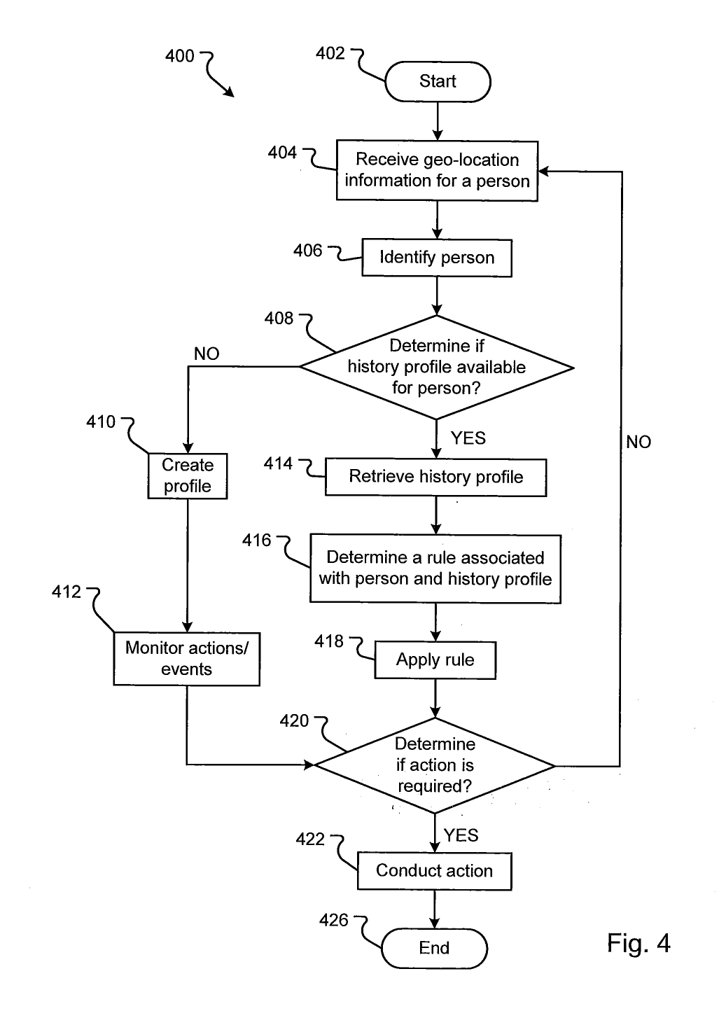

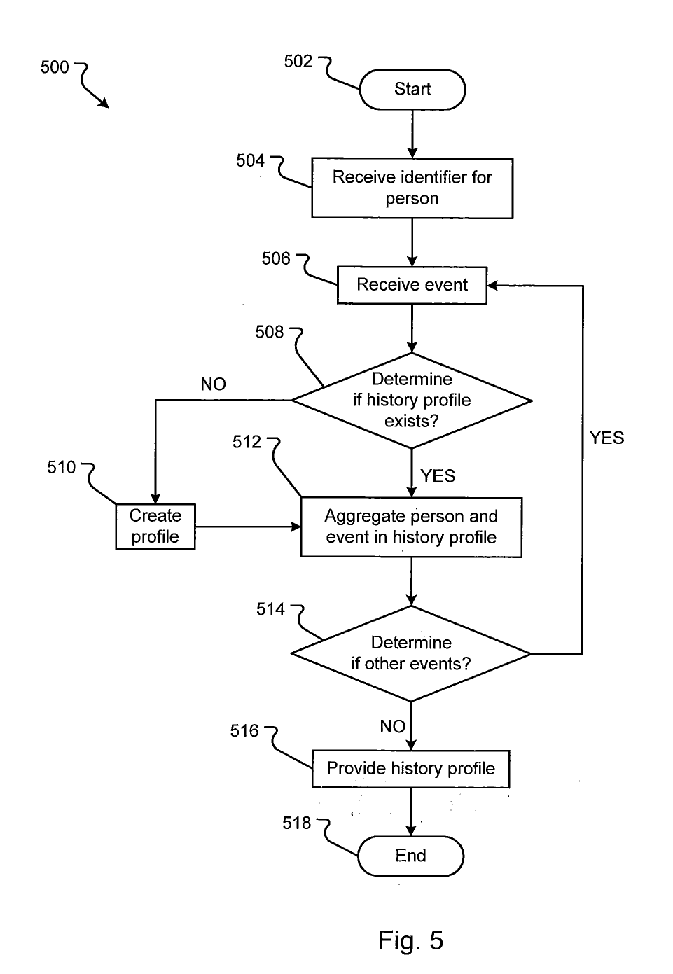

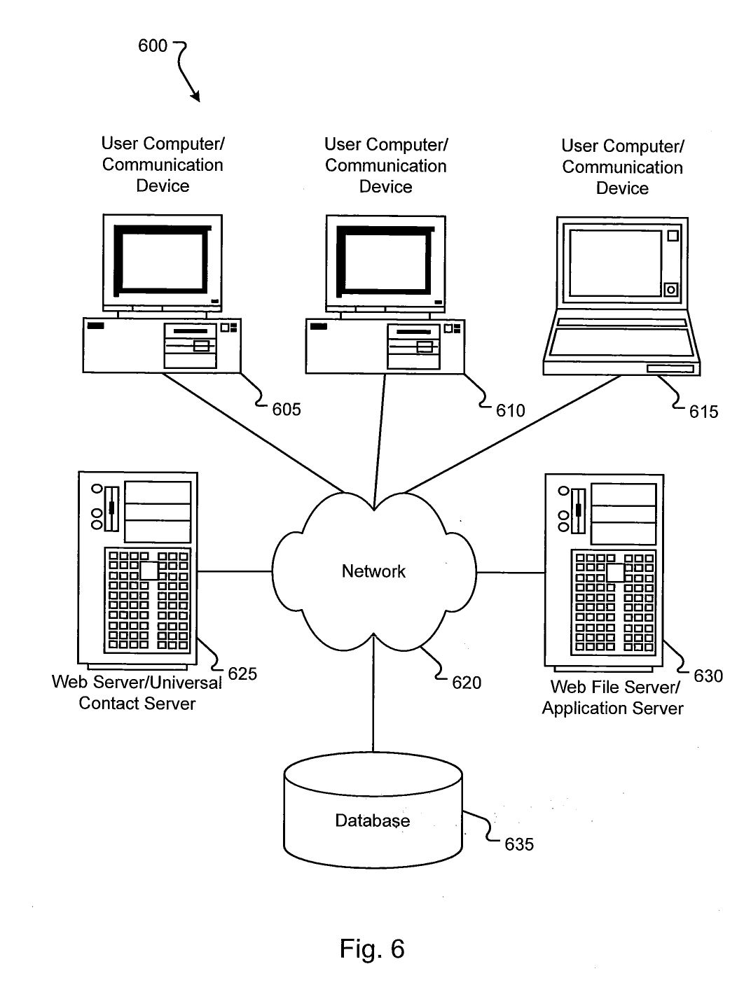

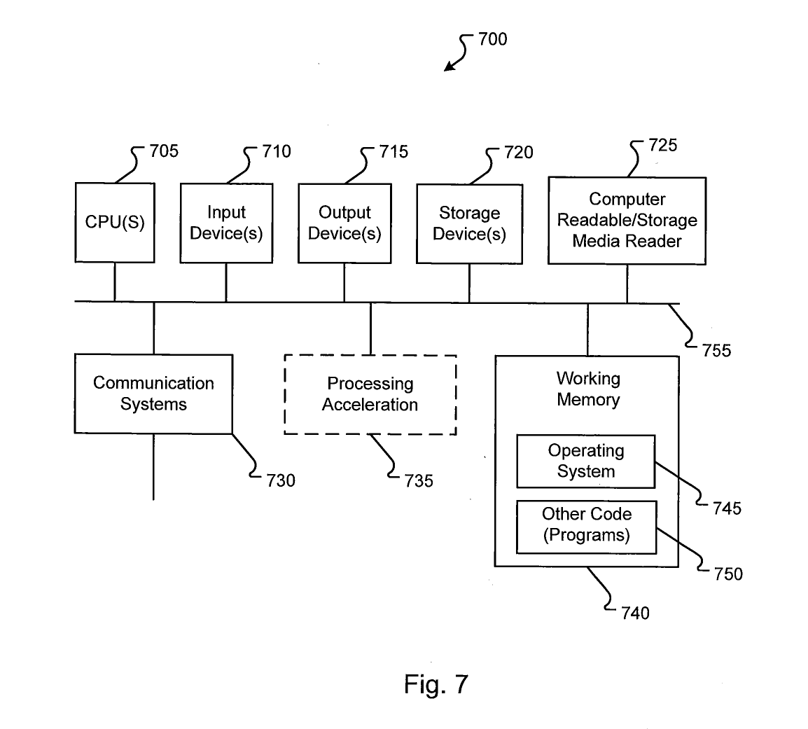

An embodiment of an interaction center system 100, for managing information about customers associated with an enterprise, is shown in FIG. 1. The components and systems described in FIG. 1, and the other figures presented hereinafter, can include computer systems, or other hardware, software, or combinations of hardware and software to execute the functions as described herein. The devices and systems described in FIGS. 1 and 2 can execute the processes described in FIGS. 4 through 5. Further, the systems and components can be executed in a computer system, as described in conjunction with FIGS. 6 and 7, as software modules or computer executable instructions. The systems and devices may also represent hardware wherein the functions are coded in a logic circuit, such as an application specific integrated circuit (ASIC) or a segment programmable gate array (FPGA). Herein the devices and components will be described by their function which may be conducted by algorithms, such as those described in conjunction with FIGS. 4 and 5.

The interaction center system 100 can include an interaction center server 102, wherein the interaction center server 102 is operable to manage information availability. An embodiment of the interaction center server 102 is described in conjunction with FIG. 2. The interaction center server 102 is in communication with an enterprise server 106 and a geo-location service 104. Throughout the description, the term “in communication with” is used to describe any electrical, light, or other signal coupling between two or more components, wherein the exchange of electrical signals may be by any protocol or format regardless of whether the connection is wired or wireless. The interaction center server 102 is operable to receive data from both the enterprise server 106 and the geo-location service 104 to manage information associated with a person that is interacting with an enterprise.

The enterprise server 106 is operable to both manage and store data for an enterprise. An enterprise can be any organization or business that may employ the interaction center server 102. An enterprise server 106 stores data in an enterprise data database 108. The enterprise data database 108 can be any hardware and/or software operable to store data. For example, the enterprise data database 108 may be a data storage system executing a database application operable to store data in any type of database, as described in conjunction with FIG. 6. The enterprise data database 108 stores data about persons associated with the enterprise, about the relationships between the enterprise and the people, and other information. Data about objects, such as vehicles, computers, or other property either sold or provided by the enterprise, may also be stored in the enterprise data database 108. Other data, associated with other functions of the enterprise, may be also stored in the enterprise data database 108. The enterprise server 106 is operable to receive information from the interaction center server 102 to determine associated data within the enterprise data database 108. The enterprise data may be retrieved and sent back to the interaction center server 102.

The geo-location service 104 is operable to receive and/or provide geo-location information to the interaction center server 102. Geo-location information can be any information about a customer's location or possible location. The geo-location information can come from a radio frequency identifier (RFID) scanner that scans the customers RFID card as the customer enters the store, from a Bluetooth interface that interacts with a customer's mobile device when entering a store, from a manual check-in on a website or kiosk (e.g., foursquare.com), from other devices that have a known physical location and interact with the customer or a device associated with the customer, from actions that can correlate to a known location (e.g., using a cellular phone and determining the GPS location of the phone, logging into an account from a home computer, etc.), from electronic or software systems that can give a possible location (e.g., a calendar that shows the customer in a business meeting), or from other actions, interactions, etc. The geo-location service 104 may be part of the interaction center system 100 and included with the interaction center server 102 or may be a third-party service that provides geo-location information. The geo-location service 104 can receive geo-location information from one or more sources. For example, the geo-location service 104 can receive geo-location information from a GPS device embedded within a communication device used and carried by a person. In other embodiments, the geo-location service 104 can receive geo-location information from a radio frequency identifier reader that is able to receive signals from an RFID card associated with a person or object. One or more other sources may be able to generally identify a location for a person and provide the information to the geo-location service 104. The geo-location information may then be integrated with the identity of the person or object, and sent by the geo-location service 104 to the interaction center server 102. As such, the interaction center server 102 can receive geo-location information for one or more persons or objects associated with or interacting with the enterprise. An additional source of geo-location information can include social media networks (e.g., Twitter bundles location information with entries posted by the user). The geo-location service 104 can monitor such social media sources and extract the location information. Likewise, it may be possible to acquire location information via other services, such as, Google Latitude.

The interaction center system 100 may also include a session border controller 110. A session border controller 110 functions as an interface between the interaction center server 102 and one or more communication devices, such as communication device 1 114, communication device 2 116, and/or communication device 3 118. The session border controller 110 is operable to communicate in any protocol or format across any type of network 112 to any type of communication device 114, 116, and/or 118. As such, the session border controller 110 is operable to send and receive messages over email, over a plain old telephone system (POTS), over cellular phone systems, through computer networks, or over any other type of communication media. As such, the network 112 may be any type of network that allows the session border controller 110, to communicate with the communication devices 114, 116, and/or 118. The communication devices 114, 116, and/or 118 likewise may be any type of communication devices including: mobile telephones, laptop computers, desktop computers, servers, thin client applications executing on computer systems, private branch exchanges having telephones that may be using session initiation protocol or other types of communication protocols, or other types of communication devices. There may be more or fewer types of communication devices than those shown in FIG. 1, as represented by the ellipses 120.

Another embodiment of the interaction center system 100, showing more detail for the interaction center server 102, is shown in FIG. 2. The interaction center server 102 includes a decision support system 202, which may be executed as a server or other computer system within the interaction center system 100. The decision support system 202 is operable to determine information about a person or object, apply event rules or business grammar, and determine information to present. The decision support system 202 can function as a management system that can automatically react to events involving one or more persons and/or objects associated with the enterprise. To react to these events, the decision support system 202 can conduct actions. These actions may include modifying information presented to an enterprise.

The decision support system 202 can include a person identifier module 204, a work flow engine 206, an action identifier module 210 and/or a user application 208. The person identifier module 204 can be operable to receive geo-location information from a geo-location service 104. From the geo-location information, the person identifier module 204 can extract an identity of a person or an object that is associated with the geo-location information. For example, the person identifier module 204 can locate' a person's name, a person's cell phone, a person's address, an object's identity, or some other information included with the geo-location information that identifies the person or object. The identifier or identity of the person or object may be sent by the person identifier module 204 to the user application 208 or the work flow engine 206. An object can be any type of property sold or provided by the enterprise. For example, an object can be a truck, a mobile phone, a computer, other inventory, and/or another item. The systems and methods described hereinafter can apply to objects or persons.

The action identifier module 210 is operable to determine an action that must be conducted in response to an event. For example, the action may include providing a person with customer service at a location associated with an enterprise, assisting a person with a product sold by an enterprise, providing information about a product, etc. There may be other actions that the action identifier module 210 can determine as one skilled in the art will understand. The action identifier module 210 is operable to identify the action based on the result of applying a rule to information received by the decision support system 202. The action may be sent to either the user application 208 and/or the work flow engine 206 to conduct the action.

The user application 208 may be a user created module that is operable to determine applicable event rules or grammar that should be applied to an event associated with the person or object. The user application 208 can communicate with the enterprise server 106. From the enterprise server 106, the user application 208 can receive information about persons, information about the enterprise or event, or historical data that can be used to both determine an event rule or business grammar associated with the person and information to input into the event rule. In some situations, the user application 208 can also apply the event rule in order to determine if an action needs to be identified by the action identifier module 210. If an action needs to be conducted, the user application 208 can send the result of the applied rule to the work flow engine 206. From there, the work flow engine 206 can retrieve the action to be conducted from the action identifier module 210.

A work flow engine 206 can complete or conduct the same operation(s) as the user application 208 or may complete other processes. For example, the work flow engine 206 may receive the action from the action identifier module 210. From the action identified, the work flow engine 206 can determine a response to the action. Thus, the work flow engine 206 can conduct the action by changing information, other messages to the enterprise. As such, the work flow engine 206 conducts the action identified by the action identifier module 210.

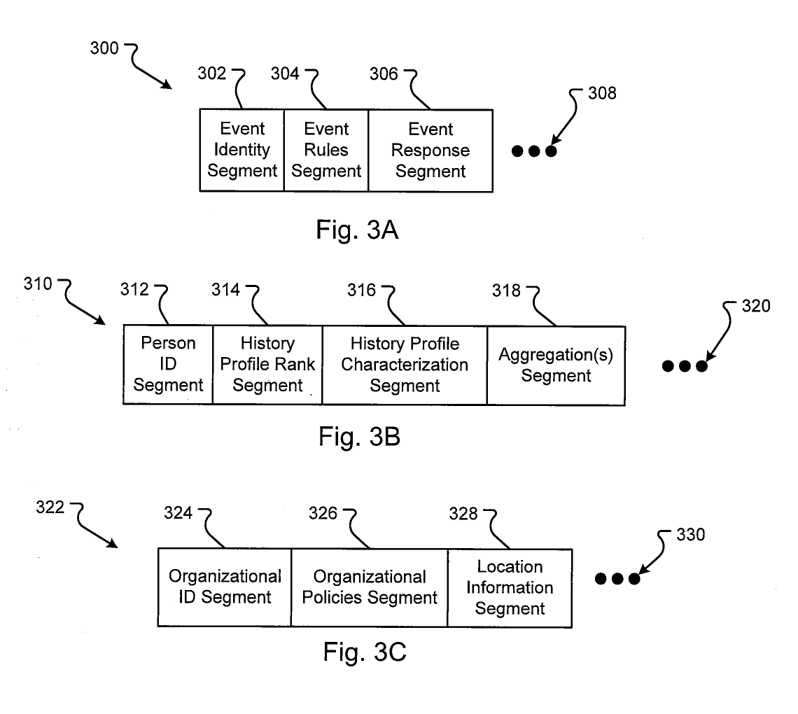

The enterprise server 106 can store and retrieve enterprise data from an enterprise data database 108, as explained in conjunction with FIG. 1. In an embodiment, the enterprise data database 108 is separated into three different databases. The databases may include a personal data database 212, a historical data database 214, and an enterprise policies database 216. The personal data database 212 can store information about one or more persons or one or more objects associated with the enterprise. The data stored, about the people or objects associated with the enterprise, is described in conjunction with FIG. 3B. The personal data may be modified or input by both the enterprise and the person that is associated with the personal data.

The enterprise server 106 may also store and retrieve enterprise policies or grammar from an enterprise policies database 216. The data stored by the enterprise policies database 216 may be as described in conjunction with FIG. 3A and/or FIG. 3C. The enterprise policies database 216 can include a grammar that is associated with events in which the enterprise is interested. A “grammar” is a set of heuristics or rules that can be applied to certain input data. For example, a grammar can determine if an event has occurred by inputting the identity of the person involved and one or more items of geo-location information. The grammar may be described as enterprise policies or business policy rules that can be set by the enterprise server 106 and applied by the decision support system 202. In other embodiments, the decision support system 202 sends information to the enterprise server 106 to determine what rules apply. Once one or more rules have been determined to apply to an event, the enterprise server 106 may then send that rule or set of rules back to the decision support system 202 for application of the rule(s).

The enterprise server 106 may also store historical data in the historical data database 214. Historical data database 214 may include information about actions or events associated with one or more persons. For example, the historical data database 214 may include previous interactions with the person. As such, the enterprise server 106 can determine when a person is likely conducting a new action. The historical data database 214 may be provided by the enterprise server 106 to a decision support system 202 to better apply event rules and to forecast events into the future, to forecast a possible location for a person, or forecast a trajectory for a person.

An embodiment of the event data structure 300, as stored within the enterprise policies database 216, is shown in FIG. 3A. The event data structure 300 may be stored, sent, or received by an enterprise policies database 216. The event data structure 300 includes an event identity segment 302, an event rules segment 304, and an event response segment 306. The event data structure 300 may have more or fewer segments than those shown in FIG. 3A, as represented by the ellipses 308.

The event identity segment 302 includes an event identity for an event that is associated with a business policy rule. The event identity could be a globally unique identifier (GUID) or some other identifier. In other embodiments, the event identity includes one or more characteristics that are associated with the rule. For example, the event identity can include the inputs required to enact a rule. For instance, the inputs may include person identities, status associated with the persons, the type of customer, or other information that is characteristics of a group of persons that are patrons of the enterprise. The inputs may also relate the rule to one or more events occurring during a period of time.

The event rules data segment 304 includes one or more business policy rules that are associated with an event. The event rules data segment 304 can include an event rule that is created by the enterprise. There may be one or more event rules associated with each event identity. Two or more people can be associated together in what is called a “Geo-Pod.” A “Geo-Pod” is a frame of reference that may include people, objects, locations, or other characteristics that provide a frame of reference. One or more event rules 304 may be applied to each Geo-Pod.

The event data structure 300 also includes an event response segment 306. The event response segment 306 can store any action that needs to be taken by the interaction center server 102 in response to applying an event rule. An event response may also include possible outcomes from applying a rule or an associated response that needs to be conducted.

Referring to FIG. 3B, data structure 310 includes personal data or data about objects, as stored in the personal data database 212. The personal data database 212 may receive, store, or send one or more portions of the data structures 310 in response to interactions with the enterprise server 106. The data structure 310 may include one or more segments. The data structure 310 may have more or fewer segments than those shown in FIG. 3B, as represented by ellipses 320. The data structure 310 can include a person identifier (ID) segment 312, a history profile rank segment 314, a history profile characterization segment user information segment 316, and a an aggregation segment 318. The person ID segment 312 includes an ID for a person. This person ID 312 can be a globally unique identifier (GUID) or some other numeric or alphanumeric identifier for the customer or object. In other embodiments, the person ID 312 includes a name, a cell phone number, an address, or some other characteristic specific to a person or object. The persons or objects associated with data structure 310 have a relationship with the enterprise or organization. For example, the person may be a customer browser, or some other type of person that patronizes or is in a relationship, which lasts over a period of time, with the enterprise. The person ID can be used by the person identifier module 204 to identify geo-location information associated with that person or object.

The data structure 310 can include a history profile rank segment 314. The history profile rank segment 314 can include a rank or some type of description or categorization of the history profile for a customer. For example, each customer may be rated based on their likelihood to buy products or based on the amount of dollar value of products the customer typically buys. Thus, a high value customer (high roller) may have a higher profile rank than a customer that merely browses frequently.

The data structure 310 may further include a history profile characterization segment 316. The history profile characterization segment 316 can store one or more descriptors for the history profile of a customer. A characterization can include some type of information that provides color or other description to the customer. For example, a characterization can include the terms high roller, may include some type of biographical information (for example, the religion, the political affiliation, the social grouping, or other information) for the customer. These characterizations may be used by an employee to better interact with a customer.

An aggregation segment 318 can store information about aggregations between the person and objects, the person and other people, the person and places, or other aggregations, or associations. Aggregations can be any type of association between a person, an object, a place, an event, or other information. For example, if a customer goes to a store with another person, an aggregation may be created associating two people together. In other embodiments, an aggregation may occur when a customer browses for a product on a website. The association between the product and the person may be saved in the aggregation segment 318. Thus, the aggregation segment 318 stores any type of associations that can be used to better understand or characterize the history of the customer.

An embodiment of an organizational data structure 322, which can be stored in an enterprise policies database 216, is shown in FIG. 3C. The organizational policies database 216 can include information about the enterprise or different information about characteristics or objects associated with the enterprise. The organizational policies data structure 322 can include more or fewer segments than those shown in FIG. 3C as represented by ellipses 330. The organizational policies data structure 322 includes an organizational identifier (ID) segment 324, an organizational policies segment 326, and/or a location information segment 328.

The organizational ID segment 324 can include a GUID, a name of the organization or enterprise, or some other identifier that uniquely identifies the organization. The organizational ID may be associated with one or more organizational policies. An organizational policy segment 326 may include a general guideline that applies to the organization or to one or more events associated with the organization. The organizational policy may include one or more rules, such as the event rules 304, described in conjunction with FIG. 3A. Each organization may have one or more groups and thus include one or more organizational identifiers. Further, each organization may have one or more organizational policies associated with each organizational ID 324.

The organizational policies data structure 322 can also include a location information segment 328. Some organizational policies or event rules may be associated with physical locations (e.g., buildings) or with objects or items that the organization operates or owns. For example, one event rule may apply to a retail facility. Likewise, an organizational policy may apply to a product that is sold or serviced by the business. As such, the location information 328 for these different locations or objects is stored in the location'information segment 328.

An embodiment of a process for acting on the history profile and history of a customer is shown in FIG. 4. Generally, the method 400 begins with a start operation 402 and terminates with an end operation 426. While a general order for the steps of the method 400 are shown in FIG. 4, the method 400 can include more or fewer steps or arrange the order of the steps differently than those shown in FIG. 4. The method 400 can be executed as a set of computer-executable instructions executed by a computer system and encoded or stored on a computer readable medium. Hereinafter, the method 400 shall be explained with reference to the systems, components, modules, software, data structures, etc. described in conjunction with FIGS. 1-3C.

The decision support system 20,2 of the interaction center server 102 receives geo-location information for a first customer from a geo-location service 104, in step 404. The geo-location information may be sent periodically. For example, geo-location information for a person or an object may be sent every minute or every hour. The geo-location information can include a location for the person or the object and an identifier for that person or object. The geo-location information can then be sent to a person identifier module 204. The person identifier module 204 can identify the person or object, in step 406. The person identifier module 204 looks for a name, a cell phone number, an address, or other information that identifies the person or object in the geo-location information. Once the person or object is identified, the person identifier module 204 sends the identity to the work flow engine 206, or the user application 208, and/or the enterprise server 106. The identity may also be sent from the user application 208 and/or work flow engine 206 to the enterprise server 106.

The enterprise server 106 can then determine the history profile associated with the person or object, in step 408. The enterprise server 106 searches for the person or object identity in the personal data database 212. Thus, the enterprise server 106 searches for a match of the person ID and the person ID segment 312 of the data structure 310. Upon finding the person ID 312, the enterprise server 106 can retrieve the history profile rank, history profile characterization, and/or the aggregation in the history profile, in step 414 from the data structure 310.

With the geo-location information and/or the user status, the enterprise server 106 may then search one or more event data structures 300 for an event identity that applies both to the person or object and to the other characteristics of the event, in step 416. The enterprise server 106 searches for an event rule that is associated with the person ID and the user history. Upon finding one or more of the event identities that match the person ID and the user history, the enterprise server 106 reads the event rule and the event response 306 and sends the information to the decision support system 202.

Upon receiving the event rule and the event response, the decision support system 202 can apply the rule, in step 418. Applying the rule requires the decision support system 202 to apply logic or other heuristic rules with the information either known by the decision support system 202 or provided by the enterprise server 106. Thus, the decision support system 202 may receive one or more items of information from the personal data database 212 as sent by the enterprise server 106. Further, the decision support system 202 may receive historical profile data from the historical data database 214 or information from the history enterprise policies database 216. For example, a decision support system 202 may receive the profile rank history profile characterization, aggregations, enterprise policies, and/or location information. The decision support system 202 may then insert the items of information and the customer history for the person or object into the rule algorithm. After inserting the information into the rule, the decision support system 202 then can calculate an outcome for the rule. The rule may also require information about a second person or object. The information about the second person or object may be included with the information about the first customer or object to determine an outcome to the rule. The first and second person or object may be members of a Geo-Pod. Part of the information that may be required for the second person or object is the history profile associated with the second person or object.

Depending upon the event response and the outcome of the rule determination by the decision support system 202, the decision support system 202 may determine if an action is required, in step 420. The work flow engine 206 and/or the user application 208 may apply the rule. The results of the rule may be sent to an action identifier module 210. The action identifier module 210 can determine the outcome of the event rule and the appropriate event response. If an action is required, the step 420 flows “YES” to step 429. In contrast, if an action is not required, the step 420 flows “NO” back to step 404. If an action is required, the action identifier module 210 can determine the appropriate response required for the decision support system 202. The work flow engine 206 can send an indication or other signal to one or more processes or entities to conduct the action(s), in step 422. The indication may even be sent to work flow engine 206 itself to conduct the action(s). The action can requires in-store (retail) personnel to behave in a defined manner. As an example, the action may be providing a specific type of customer service, offering special discounts or deals, segregating customers and helping more valuable customer, ignoring less valuable customers, etc. The work flow engine 206 may then send communications to one or more communication devices 114, 116, and/or 118 to effect the action.

An embodiment of a method 500 for establishing higher profiles is shown in FIG. 5. Generally, the method 500 begins with a start operation 502 and terminates with an end operation 518. While a general order for the steps of the method 500 are shown in FIG. 5, the method 500 can include more or fewer steps or arrange the order of the steps differently than those shown in FIG. 5. The method 500 can be executed as a set of computer-executable instructions executed by a computer system and encoded or stored on a computer readable medium. Hereinafter, the method 500 shall be explained with reference to the systems, components, modules, software, data structures, etc. described in conjunction with FIGS. 1-3C.

A person identifier 204 of the interaction center 102 receives an identifier for a person, in step 504. The identifier can be a name or other information that can uniquely identify an individual. For example, the identifier can be an address, a telephone number, social security number, or some other identifying information. The person identifier module 204 may communicate with an enterprise server 106 that may then access a personal database 212. From the personal data database 212, the enterprise server 106 can extract other identifiers or other information about the person and then return that to the decision support server 202. This other information may be sent to the person identifier module 204 which may then combine the data to send to a work flow engine 206.

The work flow engine 206 can receive an event, in step 506. An event can be any type of interaction between the person identified in step 504 and a website, store, or other establishment of the enterprise that may have a relationship with the person. The event may be sent from a geolocation service 104 to the decision support server 202. In embodiments, the event is a purchase or other consumer activity by the person. After receiving the event and the identifier, the work engine 206 can determine if a history profile exists for that person, in step 508. The work flow engine 206 can send the identifier to the enterprise server to search for a history profile from the personal data database 212. If a history profile does exist, the enterprise server can return the history profile to the work flow engine. If there is no history profile in the personal data database 212, step 508 proceeds “NO” to step 510. If a history profile is found and returned, step 508 proceeds “YES” to step 512.

The user application 208 can create a history profile. In other embodiments, the enterprise server 106 is instructed by the user application 208, to create the history profile, in step 510. The history profile can be created initially with one or more identifiers determined in step 504. Then the event may be used as input into the history profile, in step 512.

The user application 208 can put the event into certain terms or translate the format of the event for the enterprise server 106 to put into the history profile. In other embodiments, user application 208 inserts the event into the history profile. In inserting the event into the history profile, the user application 208 or enterprise server 106 is aggregating the identity of the person with the event in the history profile. Aggregation is the association of a person with an event. The event can be any type of consumer or other activity. An event can be related to a person, an object, a place, a thing, etc. For example, the event may be who accompanies a person to a store, may be what products were researched during an Internet session, can be the different stores that are visited by a person or other information that may be associated with the person.

After the aggregation, the work flow engine 206 can determine if there are other events that may need to be included with the history profile, in step 514. The work flow engine 206 can determine if there are two or more events associated with some consumer activity. For example, the event may include both an aggregation or association with a person, such as, a companion that helped with shopping experience and one or more products that were viewed during a shopping experience, plus the location of where the shopping occurred. As such, there may be two or more different events or aggregations in a single consumer activity. If there are more events in a consumer activity, step 514 proceeds YES to step 506. If there are no more events, step 514 proceeds “NO” to step 516. In step 516 a decision support server 202 can provide the history profile to the enterprise server in step 516. In other embodiments, the work flow engine 206 may provide the history profile to a user application 208 or to another process to determine the value of the customer.

The decision support system 202 can evaluate criteria in the history profile to establish a rank. The criteria may be, for example, the amount spent, the frequency of activity, the speed of purchase, etc. Each criteria may be scored and used to rank the consumer. The aggregation, ranking, and other information may be stored in the data structure 210.

FIG. 6 illustrates a block diagram of a system 600 that may function as servers, computers, or other systems provided herein. The system 600 includes one or more user computers 605, 610, and 615. The user computers 605, 610, and 615 may be general purpose personal computers (including, merely by way of example, personal computers, and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 605, 610, 615 may also have any of a variety of applications, including for example, database client and/or server applications, and web browser applications. Alternatively, the user computers 605, 610, and 615 may be any other electronic device, such as a thin-client computer, Internet-enabled mobile telephone, and/or personal digital assistant, capable of communicating via a network 620 and/or displaying and navigating web pages or other types of electronic documents. Although the exemplary system 600 is shown with three user computers, any number of user computers may be supported.

System 600 further includes a network 620. The network 620 may can be any type of network familiar to those skilled in the art that can support data communications using any of a variety of commercially-available protocols, including without limitation SIP, TCP/IP, SNA, IPX, AppleTalk, and the like. Merely by way of example, the network 620 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth™ protocol known in the art, and/or any other wireless protocol); and/or any combination of these and/or other networks.

The system may also include one or more server computers 625, 630. One server may be a web server 625, which may be used to process requests for web pages or other electronic documents from user computers 605, 610, and 620. The web server can be running an operating system including any of those discussed above, as well as any commercially-available server operating systems. The web server 625 can also run a variety of server applications, including SIP servers, HTTP servers, FTP servers, CGI servers, database servers, Java servers, and the like. In some instances, the web server 625 may publish operations available operations as one or more web services.

The system 600 may also include one or more file and or/application servers 630, which can, in addition to an operating system, include one or more applications accessible by a client running on one or more of the user computers 605, 610, 615. The server(s) 630 may be one or more general purpose computers capable of executing programs or scripts in response to the user computers 605, 610 and 615. As one example, the server may execute one or more web applications. The web application may be implemented as one or more scripts or programs written in any programming language, such as Java™, C, C#™, or C++, and/or any scripting language, such as Perl, Python, or TCL, as well as combinations of any programming/scripting languages. The application server(s) 630 may also include database servers, including without limitation those commercially available from Oracle, Microsoft, Sybase™, IBM™ and the like, which can process requests from database clients running on a user computer 605.

The web pages created by the web application server 630 may be forwarded to a user computer 605 via a web server 625. Similarly, the web server 625 may be able to receive web page requests, web services invocations, and/or input data from a user computer 605 and can forward the web page requests and/or input data to the web application server 630. In further embodiments, the server 630 may function as a file server. Although for ease of description, FIG. 6 illustrates a separate web server 625 and file/application server 630, those skilled in the art will recognize that the functions described with respect to servers 625, 630 may be performed by a single server and/or a plurality of specialized servers, depending on implementation-specific needs and parameters. The computer systems 605, 610, and 615, file server 625 and/or application server 630 may function as the system, devices, or components described in FIGS. 1-3.

The system 600 may also include a database 635. The database 635 may reside in a variety of locations. By way of example, database 635 may reside on a storage medium local to (and/or resident in) one or more of the computers 605, 610, 615, 625, 630. Alternatively, it may be remote from any or all of the computers 605, 610, 615, 625, 630, and in communication (e.g., via the network 620) with one or more of these. In a particular set of embodiments, the database 635 may reside in a storage-area network (“SAN”) familiar to those skilled in the art. Similarly, any necessary files for performing the functions attributed to the computers 605, 610, 615, 625, 630 may be stored locally on the respective computer and/or remotely, as appropriate. In one set of embodiments, the database 635 may be a relational database, such as Oracle 10i™, that is adapted to store, update, and retrieve data in response to SQL-formatted commands.

FIG. 7 illustrates one embodiment of a computer system 700 upon which the servers, computers, or other systems or components described herein may be deployed or executed. The computer system 700 is shown comprising hardware elements that may be electrically coupled via a bus 755. The hardware elements may include one or more central processing units (CPUs) 705; one or more input devices 710 (e.g., a mouse, a keyboard, etc.); and one or more output devices 715 (e.g., a display device, a printer, etc.). The computer system 700 may also include one or more storage devices 720. By way of example, storage device(s) 720 may be disk drives, optical storage devices, solid-state storage devices such as a random access memory (“RAM”) and/or a read-only memory (“ROM”), which can be programmable, flash-updateable and/or the like.

The computer system 700 may additionally include a computer-readable storage media reader 725; a communications system 730 (e.g., a modem, a network card (wireless or wired), an infra-red communication device, etc.); and working memory 740, which may include RAM and ROM devices as described above. In some embodiments, the computer system 700 may also include a processing acceleration unit 735, which can include a DSP, a special-purpose processor, and/or the like.

The computer-readable storage media reader 725 can further be connected to a computer-readable storage medium, together (and, optionally, in combination with storage device(s) 720) comprehensively representing remote, local, fixed, and/or removable storage devices plus storage media for temporarily and/or more permanently containing computer-readable information. The communications system 730 may permit data to be exchanged with the network 720 and/or any other computer described above with respect to the system 700. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 700 may also comprise software elements, shown as being currently located within a working memory 740, including an operating system 745 and/or other code 750. It should be appreciated that alternate embodiments of a computer system 700 may have numerous variations from that described above. For example, customized hardware might also be used and/or particular elements might be implemented in hardware, software (including portable software, such as applets), or both. Further, connection to other computing devices such as network input/output devices may be employed.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments have been described in detail herein, it is to be understood that the concepts may be otherwise variously embodied and employed, and that the appended claims are intended to be construed to include such variations, except as limited by the prior art.

What is claimed is:

1. A method for responding to an event associated with geo-location information, the method comprising:
a processor receiving geo-location information for a first customer;
the processor identifying the first customer;
the processor determining a history profile associated with the first customer;
the processor determining an event rule associated with the first customer and the history profile;
the processor applying the event rule;
the processor determining an action to be conducted in response to applying the event rule; and
the processor sending a signal to cause the action to be conducted, wherein the action requires in-store personnel to behave in a defined manner.

2. The method as defined in claim 1, wherein the history profile includes at least one of a group consisting of aggregations of people, aggregations of items, aggregations of events, results of previous marketing strategies, a machine address, Bluetooth capability, results of previous customer service strategies, pre-analyzed information, registrations, classifications, previously consumer activity, and anticipatory response.

3. The method as defined in claim 1, wherein the geo-location information comprises an identity for the first customer and wherein identifying the first customer comprises one of a group consisting of a.

4. The method as defined in claim 3, wherein determining the history profile associated with the first customer comprises in response to locating the identity of the first customer in the enterprise directory, retrieving the history profile associated with the first customer associated with the identity as stored within the enterprise directory.

5. The method as defined in claim 1, wherein the event rule is created by an enterprise.

6. The method as defined in claim 1, wherein applying the event rule comprises:
a decision support system retrieving at least one item of information about the first customer;
the decision support system inserting the item of information and the history profile associated with the first customer into the event rule; and
the decision support system calculating an outcome for the event rule.

7. The method as defined in claim 6, wherein the action is one of a group consisting of denying the first customer access to a location associated with an enterprise, denying the first customer access to a system associated with an enterprise, disabling a device, denying the first customer operation of a system associated with an enterprise, denying operation of a system without the first customer located at a location, sending a message to at least a second person to respond to a status associated with the first customer, and alerting the first customer of an obligation.

8. A computer readable medium having stored thereon instructions that cause a computer to execute a method for conducting an action associated with a geo-location, the instructions comprising:
instructions to receive geo-location information for at least a first customer and a second person;
instructions to identify the first customer and the second person;
instructions to determine a relationship between the first customer and the second person;
instructions to determine an event rule associated with the first customer and the second person;
instructions to apply the event rule;
instructions to determine an action to conduct in response to applying the event rule; and
instructions to cause the action to be conducted, wherein the action requires a reaction by the second person in response to the history profile associated with the first customer.

9. The computer readable medium as defined in claim 8, wherein the history profile is one of a group consisting of furlough, leave, closure, sabbatical, holiday, and vacation.

10. The computer readable medium as defined in claim 9, wherein the action is one of a group consisting of assuming the duties of the first customer a period of time, waiting for the first customer at a location before conducting an action, responding to an alert caused by the first customer, retrieving an item of property associated with the first customer, and locating the first customer to provide assistance.

11. The computer readable medium as defined in claim 8, wherein the first customer and second person are members of a geo-pod.

12. The computer readable medium as defined in claim 8, further comprising instructions to determine a second status for the second person.

13. The computer readable medium as defined in claim 8, further comprising:
instructions to apply a second event rule, wherein the second event rule is associated with the history profile associated with the second person and the history profile associated with the first customer;
instructions to determine a second action to conduct in response to applying the second event rule; and
instructions to conduct the second action, wherein the second action requires a response by a third person.

14. An interaction center system for an enterprise comprising:
a geo location service operable to provide geo location information for at least one person;
an enterprise server operable to provide personal information about at least one person and operable to provide at least one event rule associated with the person;
an interaction center server in communication with the geo location service and the enterprise server, the interaction center server operable to:
receive geo-location information for a first customer associated with the enterprise;
identify the first customer associated with the geo-location information;
provide an identity of the first customer to the enterprise server;
in response to sending the identity of the first customer to the enterprise server, receive the personal information from the enterprise server, wherein a status associated with the first customer is part of the personal information;
in response to sending the identity of the first customer to the enterprise server, receive an event rule associated with the first customer from the enterprise server;
apply the event rule with the history profile and the geo-location information;
in response to applying the event rule, determine an action to be conducted; and
sending an indication that causes the action to be conducted, wherein the action requires in-store personnel to behave in a defined manner.

15. The interaction center system as defined in claim 14, further comprising an enterprise data database in communication with the enterprise server, the enterprise data database operable to store personal information about the first customer.

16. The interaction center system as defined in claim 14, wherein the interaction center server is further operable to:
receive geo-location information for a second person associated with the enterprise, wherein the first customer and the second person are part of a geo-pod;
identify the second person associated with the geo-location information;
provide an identity of the second person to the enterprise server;
in response to sending the identity of the second person to the enterprise server, receive a second set of personal information from the enterprise server for the second person, wherein a status associated with the second person is part of the personal information;
in response to sending the identity of the second person to the enterprise server, receive an event rule associated with the first customer and the second person;
apply the event rule with the history profile and the geo-location information;
in response to applying the rule, determine an action to conduct; and
conduct the action.

17. The interaction center system as defined in claim 14, wherein the interaction center server comprises:
a decision support system, the decision support system executing:
a person identifier module operable to identify the first customer;
an action identifier module operable to identify an action to conduct;
a user application operable to send and received information with the enterprise server and operable to determine the event rule to apply; and
a work flow engine in communication with the person identifier module, action identifier module, and user application, the work flow engine operable to conduct the action, wherein the work flow engine conducts the action by at least communicating with a communication device.

18. The interaction center system as defined in claim 14, wherein the enterprise server is in communication with at least one of a personal data database, an enterprise policies database, and a historical data database.

19. The interaction center system as defined in claim 18, wherein the enterprise policies database includes a grammar associated with the event rule, wherein the interaction center server can apply the grammar to at least the geo-location information.

20. The interaction center system as defined in claim 18, wherein the personal data includes a person ID, a user preference that sets a parameter for the interaction center server, user information, and a user status.
